(19) United States
(12) Patent Application Publication
(10) Pub. No.: US 2011/0046923 A1
(43) Pub. Date: Feb. 24, 2011

(54) APPARATUS AND METHOD FOR LOW-COMPLEXITY THREE-DIMENSIONAL MESH COMPRESSION

(75) Inventors: Seung Wook Lee, Daejeon (KR); Bon Ki Koo, Daejeon (KR); Jin Seo Kim, Daejeon (KR); Young Jik Lee, Daejeon (KR); Ji Hyung Lee, Daejeon (KR); Ho Won Kim, Daejeon (KR); Chang Woo Chu, Daejeon (KR); Bon Woo Hwang, Daejeon (KR); Jeung Chul Park, Daejeon (KR); Ji Young Park, Daejeon (KR); Seong Jae Lim, Daejeon (KR); Il Kyu Park, Daejeon (KR); Yoon-Seok Choi, Daejeon (KR); Kap Kee Kim, Daejeon (KR); Euee Seon Jang, Seoul (KR); Daiyong Kim, Seoul (KR); Byoungjun Kim, Seoul (KR); Jaebum Jun, Seoul (KR); Giseok Son, Seoul (KR); Kyoung Soo Son, Seoul (KR)

Correspondence Address: AMPACC Law Group, PLLC, 6100 219th Street SW, Suite 580, Mountlake Terrace, WA, 98043, US

(73) Assignees: Electronics and Telecommunications Research Institute, Daejeon (KR); Industry-University Cooperation Foundation Hanyang University, Daejeon (KR)

(21) Appl. No.: 12/988,308

(22) PCT Filed: Apr. 6, 2009
(86) PCT No.: PCT/KR2009/001758

§ 371 Date: Oct. 15, 2010

(30) Foreign Application Priority Data
Apr. 18, 2008 (KR) 10-2008-0036371
Dec. 10, 2008 (KR) 10-2008-0125520

(51) Int. Cl. G06F 17/50

(52) U.S. Cl. 703/1

(57) ABSTRACT

An apparatus for compressing low-complexity 3D mesh, includes: a data analyzing unit for decomposing data of an input 3D mesh model into vertices information, property information representing property of the 3D mesh model, and connectivity information between vertices constituting the 3D mesh model; a mesh model quantizing unit for producing quantized vertices, property and connectivity information of the 3D mesh model by using the vertices, property and connectivity information; and a sharable vertex analysis unit for analyzing sharing information between shared vertices of the 3D mesh model. Further, the apparatus includes a data modulation unit for performing a circular DPCM prediction by using quantized values of the consecutive connectivity information of the 3D mesh model; and an entropy encoding unit for outputting coded data of the quantized vertices and property information, and differential pulse-code modulated connectivity information as a bitstream.

### TECHNICAL FIELD

The present invention relates to image compression and, more specifically, to a method and apparatus for low-complexity three-dimensional mesh compression, to employ a differential pulse-code modulation (DPCM), thereby encoding the modulated connectivity information.

### BACKGROUND ART

In computer graphics, triangular meshes are widely used to render realistic 3D images. A realistic 3D image represented by a triangular mesh includes vertices information on vertices of triangles in the mesh and connectivity information on connectivity between vertices, and hence has a much larger amount of data compared to a regular 2D image.

Accordingly, research efforts have been continuously made to solve the problems in storage and transmission of 3D images represented by triangular meshes.

Although 3D graphics is in demand recently, its use is limited because of vast amount of data being required.

For example, when vertices information of a 3D mesh model is represented using 32-bit floating-point numbers, representing a single vertex requires 96 bits (12 bytes) of memory.

Therefore, a 3D mesh model having 10,000 vertices as vertices information will require 120 KB of storage, and a 3D mesh model having 100,000 vertices will require 1.2 MB of storage.

Further, connectivity information may include repeated vertex references, requiring a significant amount of storage.

To cope with the requirement of the huge amount of data, coding schemes for compressing 3D images have been developed. For example, a 3D mesh coding (3DMC) scheme is adopted in virtual reality modeling language (VRML) and the MPEG-4 ISO/IEC standard. Particularly, in the MPEG-4 standard, the 3DMC scheme provides a compression tool for an IndexedFaceSet node representing a 3D model in a VRML file, and enables compression and decompression of the geometry and connectivity information of the 3D model to thereby increase efficiency of transmission of 3D mesh information.

FIG. 1 is a block diagram of an existing 3DMC encoder 110.

Referring to FIG. 1, the existing 3DMC encoder 110 includes a topological surgery module 111 decomposing a 3D mesh model being source data having vertex, connectivity and property information into 2D meshes, a vertex information encoding module 112, a connectivity information encoding module 113, a property information encoding module 114, and an entropy encoding module 115 compressing the results encoded by the vertex information encoding module 112, connectivity information encoding module 113 and property information encoding module 114 into a 3DMC bitstream.

In the 3DMC encoder 110, the main feature of 3DMC is a topological surgery performed by the topological surgery module 111 to obtain a high compression ratio. In topological surgery, a triangular mesh of a 3D model is assumed to be homeomorphic to a sphere, and is converted into a 2D mesh structure by cutting the triangular mesh along the cutting edges.

FIG. 2 is a block diagram of a 3DMC decoder 210 corresponding to the 3DMC encoder 110 of FIG. 1.

Referring to FIG. 2, the 3DMC decoder 210 includes an entropy information decoding module 211, vertex information decoding module 212, connectivity information decoding module 213, property information decoding module 214, and topological synthesis module 215, and restores the original 3D model data from a 3DMC bitstream.

FIG. 3 illustrates an overall structure of a bitstream representing mesh information of a 3D model produced by the encoder of FIG. 1.

Referring to FIG. 3, a bitstream representing encoded mesh information of a 3D model includes a triangle tree 303 related to a binary triangle spanning tree composed of triangular strips, a vertex graph 301 indicating edges between vertices cutting the 3D mesh, and triangle data 305 related to data values of the 3D mesh.

FIGS. 4 to 7 illustrate steps involved in topological surgery of a 3D mesh model.

A 3D mesh model shown in FIG. 4 is cut along the cut edges (marked in thick lines), resulting in a triangle tree shown in FIG. 5.

For fast processing of graphics data, objects are generally modeled in units of triangles, and triangles are preferably connected together to form a strip or fan rather than an arbitrary pattern. Repeated symbols in graphics data result in a high compression ratio. In conventional topological surgery, a 3D mesh model is cut along the cut edges into a triangle tree as shown in FIG. 5.

Next, a reference point is selected from the triangle tree, and a link is made between the selected reference point and the outermost vertex of a branching triangle, resulting in a vertex graph as shown in FIG. 6.

Then, a bounding loop is formed using the vertex graph, as shown in FIG. 7.

As described above, in the MPEG-4 3DMC scheme, compression of a 3D model represented by an IndexedFaceSet node involves the process of topological surgery to decompose the mesh structure of the 3D model into a 2D mesh map structure.

Although, representing a 3D mesh structure by a vertex graph and triangle tree enables achievement of a high compression ratio for a 3D model, which may cause a problem of changing original vertex position information of the 3D model.

That is, for further compression after topological surgery, the existing 3DMC encoder sends a newly indexed version of the vertex position information of the 3D model to the 3DMC decoder.

Consequently, the 3DMC decoder may be unaware of the original vertex position information of the 3D model so that an animation application requiring information on the order of vertices may be not supported.

In addition, whereas topological surgery, decomposing the connectivity information of a 3D mesh into a 2D mesh map, triangle tree and vertex graph, is effective for achievement of a high compression ratio, but it involves complex operations consuming most of the time and resources needed in compression.

### DISCLOSURE OF INVENTION

### Technical Problem

In view of the above, the present invention provides a low complexity 3D mesh compression apparatus that can reduce complexity and enhance efficiency in compression of a 3D mesh model by employing DPCM in quantized connectivity information and encoding the modulated connectivity information without performing topological surgery.

Further, the present invention provides a 3D mesh compression method using the above low complexity 3D mesh compression apparatus.

Furthermore, the present invention provides a computer-readable medium storing a computer-executable program to execute the above 3D mesh compression method.

### Technical Solution

In accordance with a first aspect of the present invention, there is provided an apparatus for compressing low-complexity three-dimensional (3D) mesh, including: a data analyzing unit for decomposing data of an input 3D mesh model into vertices information, property information representing property of the 3D mesh model, and connectivity information between vertices constituting the 3D mesh model; a mesh model quantizing unit for producing quantized vertices, property and connectivity information of the 3D mesh model by using the vertices, property and connectivity information; a sharable vertex analysis unit for analyzing sharing information between shared vertices of the 3D mesh model; a data modulation unit for performing a circular DPCM prediction by using quantized values of the consecutive connectivity information of the 3D mesh model; and an entropy encoding unit for outputting coded data of the quantized vertices and property information, and differential pulse-code modulated connectivity information as a bitstream.

In accordance with a second aspect of the present invention, there is provided a method of compressing low complexity 3D mesh models, including: decomposing an input 3D mesh model into vertices information, property information representing property of the 3D mesh model, and connectivity information between vertices constituting the 3D mesh model; producing quantized vertices, property and connectivity information of the 3D mesh model by using the vertices, property and connectivity information; analyzing sharing information between shared vertices of the 3D mesh model; performing a circular DPCM prediction by using quantized values of the consecutive connectivity information of the 3D mesh model; and outputting coded data of the quantized vertices and property information, and differential pulse-code modulated connectivity information as a bitstream.

In accordance with a third aspect of the present invention, there is provided a computer-readable storage medium for storing a computer-executable program to execute the method described above.

### ADVANTAGEOUS EFFECTS

In accordance with the present invention, a 3D mesh model can be compressed with lowered complexity and enhanced efficiency by employing DPCM in the quantized connectivity information and encoding the modulated connectivity information without performing topological surgery. Accordingly, the compressed 3D mesh model can be rapidly and accurately decompressed, enhancing resource usage efficiency.

### BRIEF DESCRIPTION OF DRAWINGS

The objects and features of the present invention will become apparent from the following description of embodiments given in conjunction with the accompanying drawings, in which:

FIG. 1 is a block diagram of an existing 3DMC encoder;

FIG. 2 is a block diagram of a 3DMC decoder corresponding to the 3DMC encoder of FIG. 1;

FIG. 3 illustrates an overall structure of a bitstream representing mesh information of a 3D model produced by the encoder of FIG. 1.

FIGS. 4 to 7 illustrate steps of topological surgery of a mesh of a conventional 3D model.

FIG. 8 is a block diagram of a 3D mesh compression apparatus in accordance with an embodiment of the present invention;

FIG. 9 is an example of a binary arithmetic coding (BAC) in accordance with an embodiment of the present invention.

FIG. 10 illustrates a quantization scheme employed in the present invention;

FIGS. 11 to 14 are diagrams of type information determined by analyzing shared vertices;

FIG. 15 is a flow chart of coding method of circular difference; and

FIG. 16 is a flow chart of an arithmetic coding and a preprocessing method therefor.

### BEST MODE FOR CARRYING OUT THE INVENTION

Hereinafter, embodiments of the present invention will be described in detail with reference to the accompanying drawings, which form a part hereof.

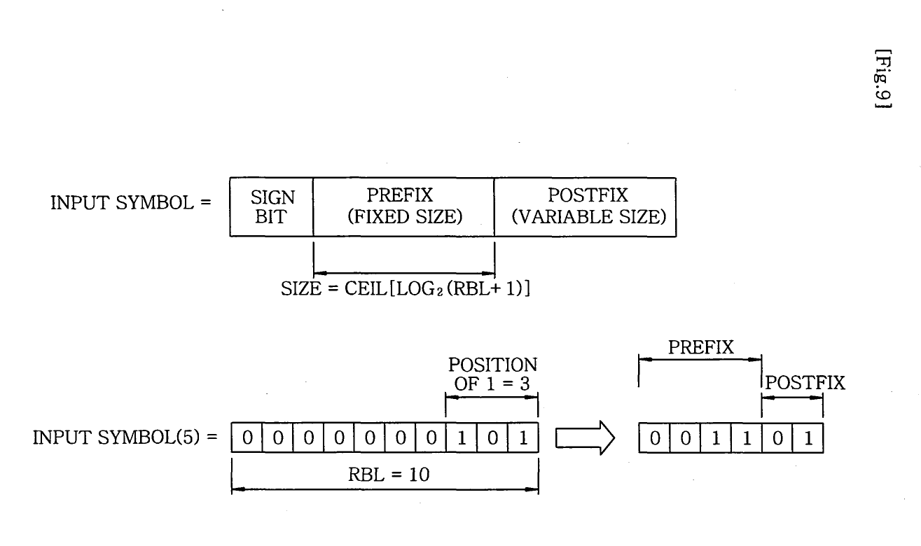

FIG. 8 is a block diagram of a 3D mesh compression apparatus in accordance with an embodiment of the present invention.

Referring to FIG. 8, the 3D mesh compression apparatus includes a data analyzing unit 510, a mesh model quantizing unit 520, a sharable vertex analysis unit 521, a data modulation unit 530 and an entropy encoding unit 540. The data modulation unit 530 includes a preprocessing unit 531 and a DPCM unit 532.

In the low complexity 3D mesh compression apparatus, the data analyzing unit 510 decomposes input 3D mesh model data into vertices information 511 specific to vertices of the 3D model, property information 512 specific to property of the 3D model, and connectivity information 513 between vertices of the 3D model specific to associations.

More specifically, the vertices information 511 can be represented by 3D coordinates of vertices of a 3D model. A single vertex can be represented by three floating-point numbers indicating the x, y and z-coordinates.

The property information 512 can include normals, colors, and texture coordinates of a FaceSet representing the 3D mesh model.

The connectivity information 513 can be represented by an index list containing indices of three or more vertices forming a polygon (referred to as IndexedFaceSet or FaceSet).

The data analyzing unit 510 may include an operating unit (not shown) and the operating unit can be implemented by, e.g., a microprocessor, which can subdivide a large 3D mesh model having a complexity value greater than a preset complexity threshold into multiple smaller 3D mesh models. Further, the data analyzing unit 510 may also include a header (not shown) storing data about the vertices, property and connectivity information of the 3D mesh model.

That is, when a 3D mesh model having too many vertices is coded, the 3D mesh coding apparatus may experience overload owing to excessive computations. Hence, to prevent coding errors or significant coding speed reduction due to the overload, a complexity threshold is set in advance so that a large 3D mesh model having a complexity value greater than the preset complexity threshold can be subdivided into multiple smaller 3D mesh models.

The complexity of a 3D mesh model can be determined in correspondence with the number of faces of the FaceSet forming the 3D mesh model, and can be adjusted in various ways according to operational environments or usage of the 3D mesh encoding apparatus.

The mesh model quantizing unit 520 can produce quantized vertex and property information by using vertex information 511 and property information 512 of a 3D mesh model, and connectivity information 513 between vertices of the 3D mesh model. And these three values 511, 512 and 513 are analyzed from the data analyzing unit 510.

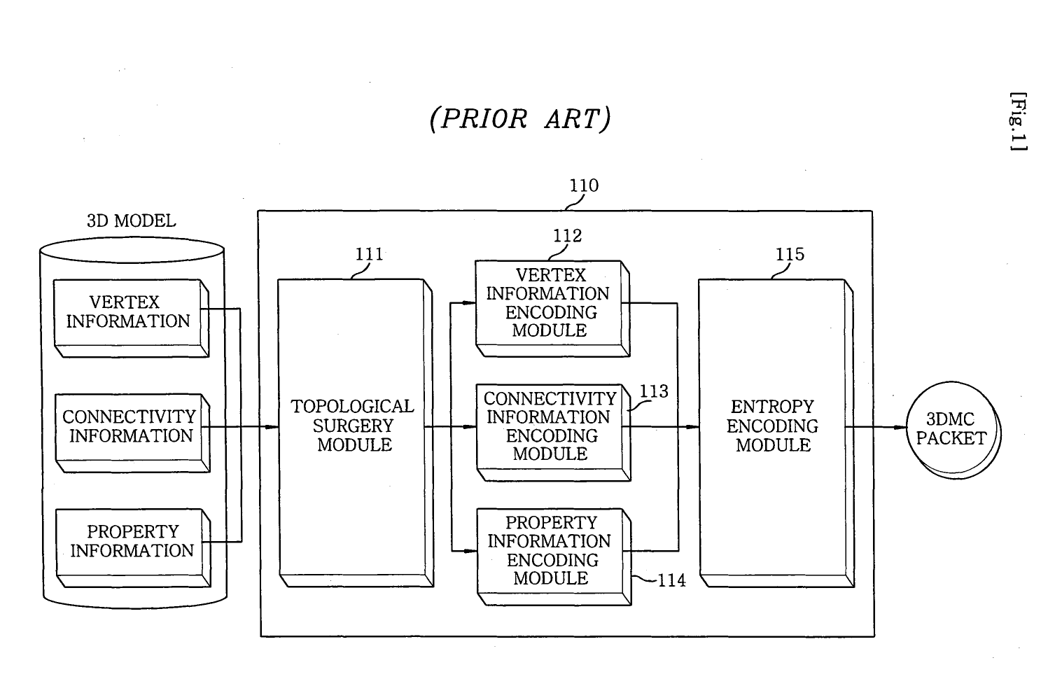

The mesh model quantizing unit 520 can produce quantized values by using Math FIG. 1.

$$MathFigure 1$$

$$Q ( {x}_{i} ) = floor [ \frac{{x}_{i} - min}{max - min} \times ( {2}^{t} - 1 ) + 0.5 ] \qquad [ Math . 1 ]$$

Where, ‘floor[ ]’, ‘Xi’, ‘t’ denote a round down operation, an input value of a quantization and a quantization parameter, respectively. Further, ‘max’ and ‘min’ denote maximum and minimum value of the input value, respectively.

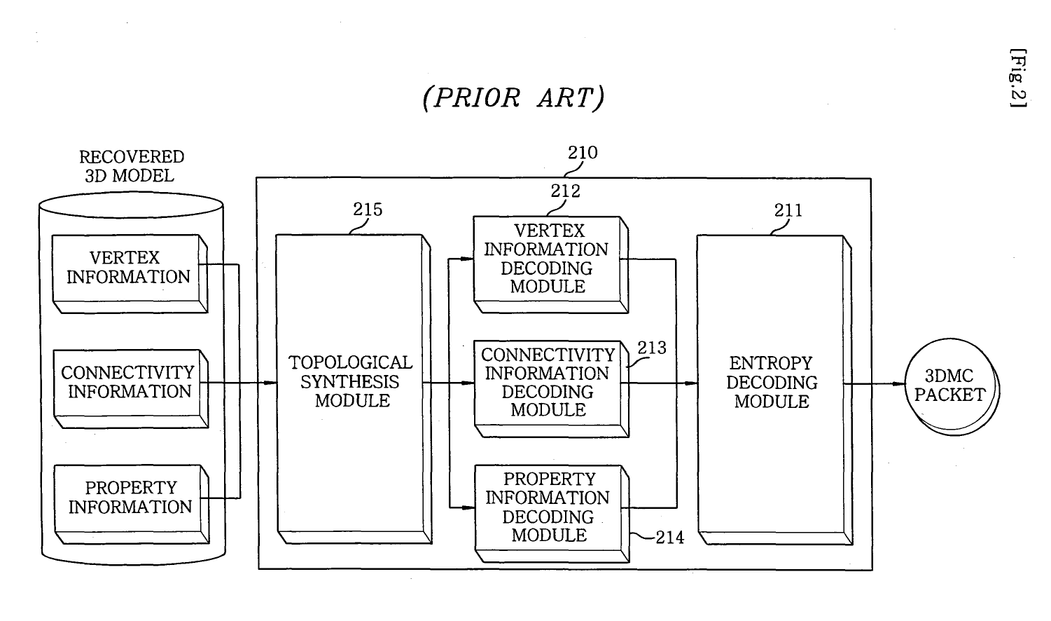

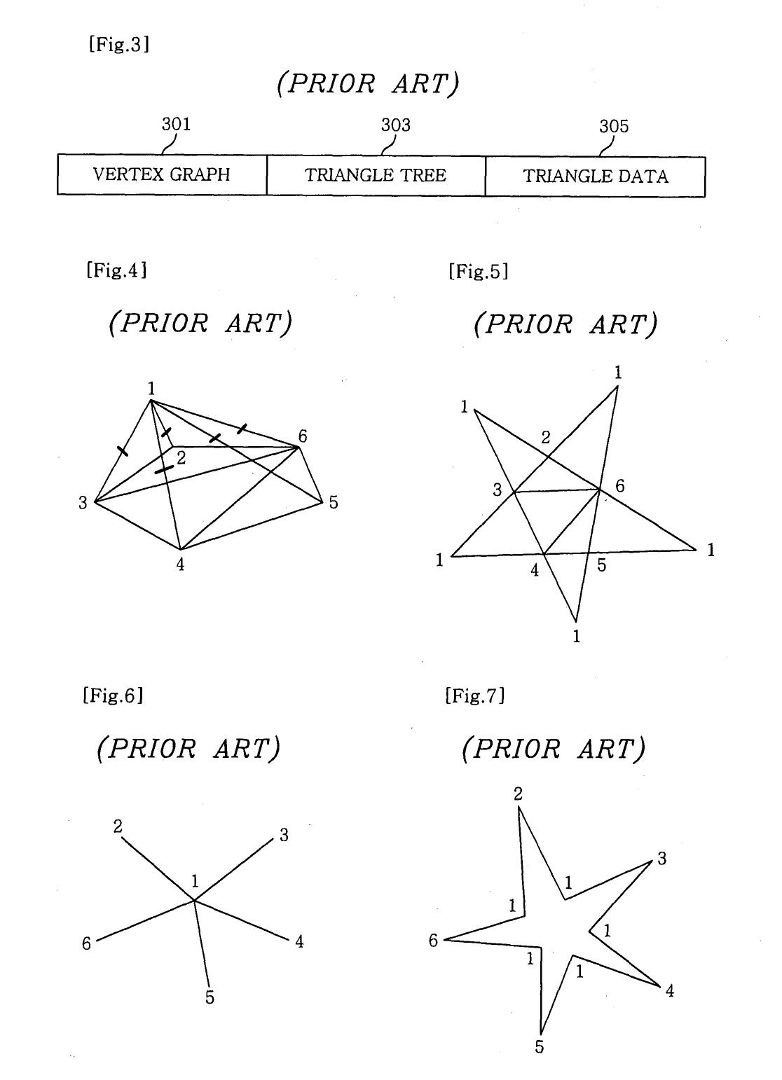

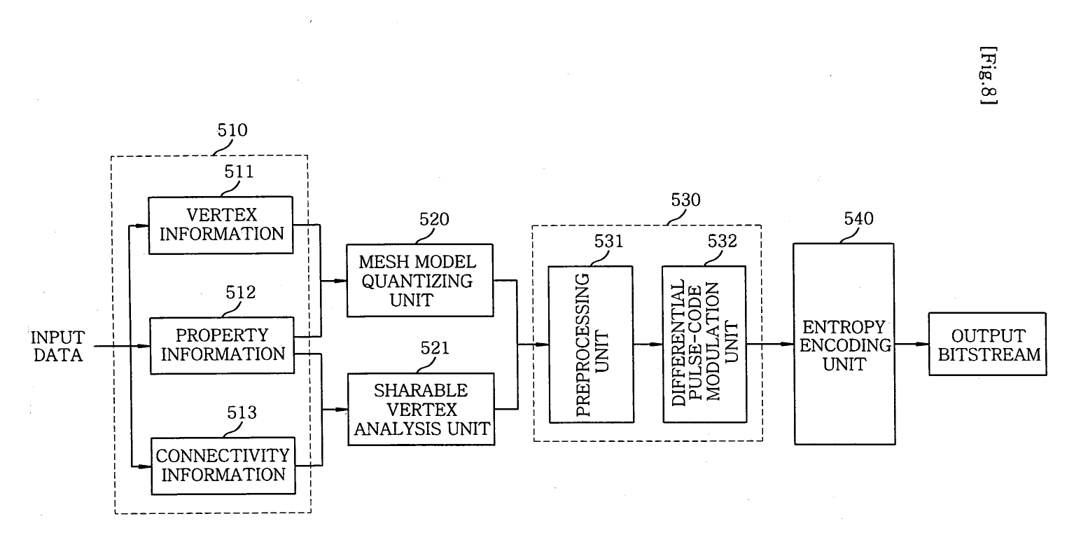

The shared vertex analysis unit 521 analyzes sharing information between the vertices of the 3D mesh model, which is called SVA (Sharable Vertex Analysis). The SVA is a method for removing duplicity between the vertices by analyzing vertex information between a previous face and a current face and is classified into 4 types. Further, type information (mode information) is obtained by using Math FIG. 2.

$$MathFigure 2$$

$${F}_{i} = ( {v}_{i , 1} , {v}_{i , 2} , {v}_{i , 3} ) \\ Z ( {F}_{i - 1} , {F}_{i} ) = {\sum }_{j = 1}^{3} {\sum }_{k = 1}^{3} Eq ( {v}_{i - 1 , j} , {v}_{i , k} ) , i = 1 , 2 , 3 … , N \\ Eq ( a , b ) = 0 ( if a \neq b ) , 1 ( otherwise ) \\ Where {F}_{i} \text{:} current face , \\ Z ( {F}_{i - 1} , {F}_{i} ) \text{:} type information \qquad [ Math . 2 ]$$

The preprocessing unit 531 of the data modulation unit 530 calculates difference values between pairs of consecutive data in order of index embedded in connectivity information of the 3D mesh model and makes order of indexes in the pairs of data such that the difference values have minimum values, in order to reduce the difference values.

The differential pulse-code modulation unit 532 performs a circular differential pulse-code modulation according to the connectivity information by using the consecutive connectivity information of the 3D mesh model.

Further, the entropy encoding unit 540 performs arithmetic coding, binary arithmetic coding and bit-precision coding on the vertex and property information of the 3D mesh model and the differential pulse-code modulated connectivity information and outputs the entropy coded-data of the 3D mesh model. When performing the entropy coding, a sign of an input symbol is determined by inserting one sign bit and entropy coding is applied to an absolute value.

First, arithmetic coding (AC) of the entropy encoding unit 540 will be described as follows.

In order to employ the AC, probability distribution of each symbol is needed, but it is difficult to calculate all the probability of the symbols since the number of symbols is increased in proportion to the number of vertices of the 3D mesh model. Therefore, the AC is performed after an input value is divided a quotient and a remainder.

In case of vertex coordinates, the number of symbols is determined according to a size of quantization bits and is relatively small value so that the AC is performed without a quotient and remainder operation.

Next, Bit Precision Coding (BPC) method in the entropy encoding unit 540 will be described as follows.

In table 1, when input symbols are 5, 3, 8 and 2, how each symbol is coded according to the BPL is described.

TABLE 1
BPC and BPL table

| | Symbol | | | | |
|---|---|---|---|---|---|
| BPL | 5 | 3 | 8 | 2 | Total bits |
| 1 | 111110 | 1110 | 111111110 | 110 | 22 |
| 2 | 1110 | 1100 | 111110 | 10 | 16 |
| 3 | 101 | 011 | 111001 | 010 | 15 |
| 4 | 0101 | 0011 | 1000 | 0010 | 16 |
| 5 | 00101 | 00011 | 01000 | 00010 | 20 |
| 6 | 00101 | 000011 | 001000 | 000010 | 24 |
| 7 | 0000101 | 0000011 | 0000010 | 0000010 | 28 |

In case the BPL (Bit Precision Length) is ‘2’ in table 1, a maximal representable value is “11(2)=3”. The first input symbol ‘5’ equal to “3+2”, thus can be represented by “11(2)+10(2)”. The next input symbol ‘3’ is able to be represented by “3+0”, which is represented by “11(2)+00(2)”. Likewise, ‘8’ and ‘2’ are represented by “11(2)+11(2)+00(2)”, i.e., “3+3+2” and ‘10(2)’ respectively. When decoding, the bitstream ‘11101100’ and BPL, ‘2’ are already given. When reading the bitstream as long as the BPL, “11(2)=3” is obtained. Here, bit values can be added rear side of the ‘11(2)’ so that, when reading the next two bits, “10(2)=2” is obtained.

Consequently, “10(2)=2” is not the same value as ‘11(2)’, a symbol reading is ended and “3+2=5” is decoded. The other symbols are decoded by such a method. In this case ‘11(2)’ acts like a termination code for each symbol.

In case of the BPL is 3 in table 1, ‘5’ is represented by ‘101(2)’, but ‘8’ is represented by “111(2)+001(2)=7+1”.

That is, as described in table 1, a size of the bitstream is variable according to the BPL. When the BPL is 3, the number of total bits needed to encode a given symbol, “5, 3, 8, 2” is least. Therefore, the BPL for this sequence is selected as 3.

As shown in table 1, in order to get optimal BPL, the BPC is required to be performed for every BPL, which takes a long time. In order to reduce the time, a frequency table is used as shown in table 2 below.

TABLE 2
Number of Bits assigned to Symbol

| | | | | | | BPL = |
|---|---|---|---|---|---|---|
| Symbol | Frequency | BPL(=1) | BPL(=2) | BPL(=3) | . . . | Floor[log₂Max + 1] − 1 |
| 0 | F₀ | F₀ × 1 | F₀ × 2 | F₀ × 3 | . . . | F₀ × BPL |
| 1 | F₁ | F₁ × 2 | F₁ × 2 | F₁ × 3 | . . . | F₁ × BPL |
| 2 | F₂ | F₂ × 3 | F₂ × 2 | F₂ × 3 | . . . | F₂ × BPL |
| . . . | . . . | . . . | . . . | . . . | . . . | |
| Max | F_{Max} | F_{Max} × | F_{Max} × | F_{Max} × | | F_{Max} × BPL × |
| | | Max + 1 | BPL × | BPL × | | floor[Max/(2^{BPL} − |
| | | | floor[Max/ | floor[Max/ | | 1) + 1] |
| | | | (2^{BPL} − 1) + 1] | (2^{BPL} − 1) + 1] | | |

As shown in table 2, by using the frequency table, the number of required bits for given BPL for one symbol are calculated, and we can compute total number of bits required for symbols by multiplying the frequency (Fx). Accordingly, all the number of bits required to the other symbol can be calculated. The required number of bits when performing the BPC on a given symbol S is equal to “BPL×floor[S/(2BPL−1)+1]”. Therefore, if the number of S is FS, the number of bits required to perform the BPC on the every S is equal to “FS×BPL×floor[S/(2BPL−1)+1]”. When calculating the BPL, calculating is performed until “BPL=floor[ log₂Max+1]−1” because, when the BPL is equal to or larger than the “BPL=floor[ log₂Max+1]−1”, the BPC is not used but general binary representation is used. Thus we have two cases:

First one is optimal BPL case: we have required number of bits for every BPLs (form 1 to floor[ log₂Max+1]−1) and choose corresponding BPL which makes smallest bitstream.

Second one is normal binarization, which simply converts input into binary number. In this case the number of bits required is “total number of symbols×floor[ log 2Max+1]”. We choose the case between two options, which makes a smaller bitstream.

The table based BPC may be used to enhance compression ratio. As shown in table 3, each symbol is represented by the BPL and a payload, and the BPL is determined according to a size of the symbol.

TABLE 3
Table based BPC

| Symbol | BPL (representation) | Payload | | |
|---|---|---|---|---|
| 0 | 0 (000) | — | | |
| 1 | 1 (001) | — | | |
| 2 | 2 (010) | — | | |
| 3 | 3 (011) | 00 | | |
| 4 | 3 (011) | 01 | | |
| 5 | 3 (011) | 10 | {close oversize brace} | 2² |
| 6 | 3 (011) | 11 | | |
| 7 | 4 (100) | 000 | | |
| . . . | . . . | . . . | {close oversize brace} | 2³ |
| 14 | 4 (100) | 111 | | |
| 15 | 5 (101) | 0000 | | |
| . . . | . . . | . . . | {close oversize brace} | 2⁴ |
| 30 | 5 (101) | 1111 | | |

As shown in table 3, assuming that a maximum value is 30 and input symbols are “0 3 2 14”,

‘0’=(BPL, Payload)=(000, —)=‘000’;

‘3’=(BPL, Payload)=(011, 00)=‘01100’;

‘2’=(BPL, Payload)=(010, —)=‘010’; and

‘14’=(BPL, Payload)=(100, 111)=‘100111’.

That is, a final BPC value is ‘00001100010100111’. In a decoding process, bits of the given BPL are read and a reverse process is performed. The process is much faster than the AC or Hoffman coding.

A Binary Arithmetic Coding (BAC) will be described as follows.

When performing the BAC, a binary value is used as an input value of the BAC. In accordance with an embodiment of the present invention, the binary input value is converted into a small data by a preprocessing and inputted into the entropy encoding unit, then outputted as a bitstream. In some set of symbols, the number of bits required to represent the symbols as binary numbers is the same as that required to represent a maximum value among the set. Here, the required number of bits is defined as Representation Bit Length (RBL).

FIG. 9 describes an example of BAC in accordance with an embodiment of the present invention and a case where an input symbol is ‘5’ and a maximum value is ‘1023’,i.e., “ceil[ log 2(1023+1)]=10”. Here, ‘5’ is represented by 10 bits of binary number ‘0000000101’. One bit of sign bit is inserted to represent the sign and a value of the sign bit is outputted as a bitstream. In the present invention, an input binary number except for the sign is represented by a prefix having a fixed size of BPL and a postfix having a variable size. A value of prefix denotes a position of 1 which is the most distant from the least significant bit (LSB). The value of prefix is “ceil[ log₂(5+1)]=3” in this example and ranges from 0 to “RBL=10” thus can be represented by “ceil[ log₂(RBL+1)]” bits.

Here, ceil[ ] is a round up operation. The prefix is defined by a size of “ceil[ log 2(RBL+1)]” and is represented by four bits of “3=0011(2)”. Meanwhile, postfix is a total bitstream from next to the ‘1’ which is the most distant from the LSB of an original binary expression. In this example, the postfix is ‘01’. Accordingly, ‘0000000101’ is preprocessed and becomes “prefix+postfix=001101”, which is inputted to the BAC.

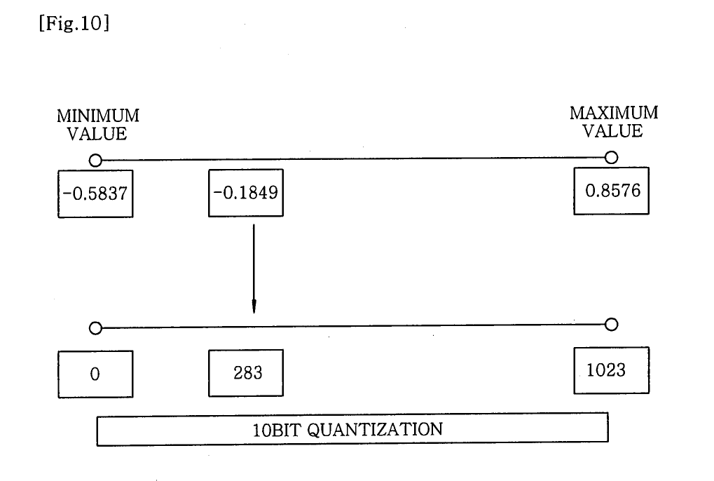

FIG. 10 illustrates the quantization scheme employed in the present invention.

In FIG. 10, the minimum value is ‘−0.5837’, the maximum value is ‘0.8576’, and hence the quantization interval becomes ‘1.4413’ (0.8576-(−0.5837)). With the quantization level of 10 bits, dividing the interval ‘1.4413’ by the number of steps ‘1024’ produces the step size ‘0.0019’. Using Equation 1, a data value of ‘−0.1849’ is quantized into an integer value of ‘283’.

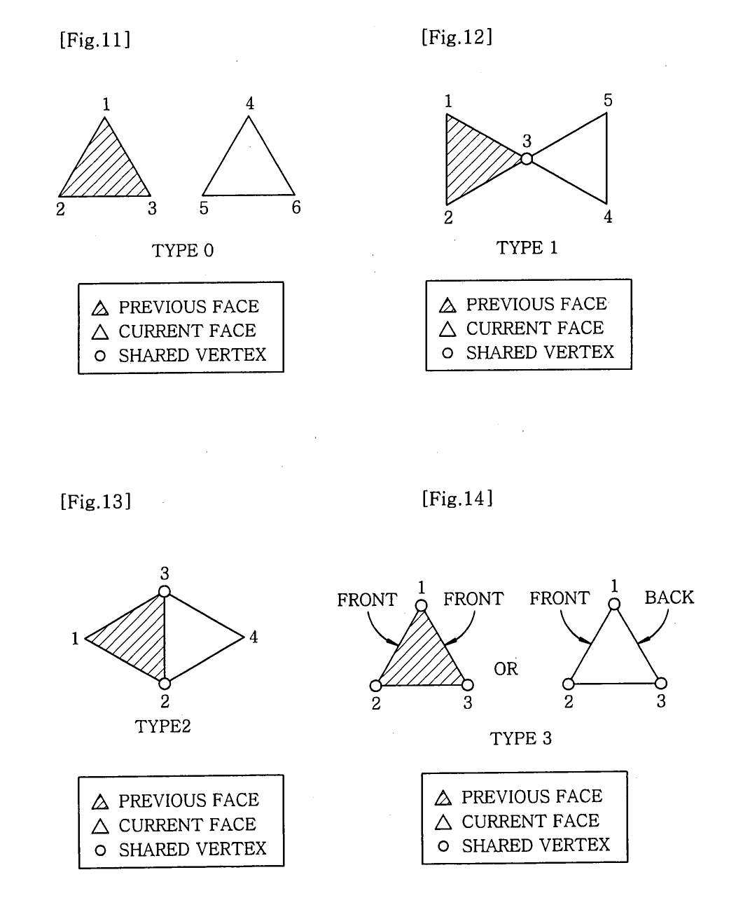

Referring to FIGS. 11 to 14, type information is obtained by using the number of shared vertices between a previous face and a current face. For example, when vertex indexes of the previous face and current face are (0, 1, 2) and (2, 3, 0), respectively, two indexes, i.e., ‘0’ and ‘2’ are shared, the Type 2 is selected. The type information is represented by four information, i.e., Type 0, Type 1, Type 2 and Type 3. In order to code and/or decode the coded data by using a sharing relationship between the previous face and current face, position information, face direction information and a difference value between two vertex indexes that is not shared are required. In case of triangle mesh, the position information is represented by one of three values of 0, 1, 2. In case of Type 1 and the Type 2, the position information having same index value and the position information having different index value are coded, respectively. The face direction information denotes whether a direction of the current face is the same as that of the previous face and is represented by ‘0’ and ‘1’. Such a data is differential pulse-code modulated by the differential pulse-code modulation unit 532, as shown in FIG. 5. Here, a preprocessing is performed in the preprocessing unit 531 to reduce a range of differential value. In the present invention, a circular difference coding is performed by the sharable vertex analysis unit 521 and the differential pulse-code modulation unit 532. The difference value obtained by circular difference is defined as a Differential Index Value (DIV).

First, the Type 0 represents a case where no shared vertex exists between the previous face and current face. In order to code such a data, the type information and three DIVs are used. Secondly, the Type 1 represents a case where one shared vertex exists between the previous face and current face. In order to code such a data, the type information, position information having the same index value and two DIVs are used. Thirdly, the Type 2 represents a case where two shared vertices exist between the previous face and current face. In order to code such a data, the type information, the position information having different index value, one DIV and the face direction information are used. Fourthly, the Type 3 represents a case where three shared vertices exist between the previous face and current face. In order to code such a data, the type information and the face direction information are used.

The coding method described above may have a problem. When a texture coordinate index is not used for texture, there may be a case that the same CoordIndex values are shared. In such a case, it is required that a restored CoordIndex value is not rotated. For example, in the Type 2 described above, (1, 2, 3) can be restored into (3, 1, 2), which may have a problem except for making a mesh. In order to solve the problem, processes as follows are added.
If property information exists in an input 3D model, position fixing information is added when applying an SVA.
The added position fixing information tells that how many times the restored CoordIndex should be rotated.
The rotation number is determined one of ‘0’ (no rotation), ‘1’ (one rotation) and ‘2’ (two rotation).
For example, in case the original is (1, 2, 3), the rotation number for fixing the position is 1 and the restored value by the SVA is (3, 1, 2), the restored value is rotated clockwise one time to be outputted as (1, 2, 3).

Table 4 below describes an example of the CoordIndex value of virtual reality modeling language (VRML) data.

TABLE 4
SVA for typical example

| Face Index | | | | | | Face | | | |
|---|---|---|---|---|---|---|---|---|---|
| Information | | | | Type | Position | Direction | DIV1 | DIV2 | DIV3 |
| F1 | 0 | 1 | 2 | — | — | — | 0 | 1 | 2 |
| F2 | 2 | 3 | 0 | 2 | 1 | 1 | 2 | — | — |
| F3 | 4 | 5 | 0 | 1 | 2 | — | 2 | 2 | — |
| F4 | 0 | 3 | 4 | 2 | 1 | 1 | −2 | — | — |
| F5 | 5 | 6 | 1 | 0 | — | — | 5 | 3 | −3 |

In table 4, a first face F1 and a second face F2 are (0, 1, 2) and (2, 3, 0), respectively. A first index is transmitted directly to the decoder. In F2, ‘0’ and ‘2’ are shared so that the Type is Type 2. The index that is not shared is a second index of ‘0, 1, 2’ so that position information is 1. The value of DIV1 becomes “3−1”,i.e., ‘2’. When decoding the F2, previous information F1 is decoded in advance. The Type information is ‘2’ so that two indexes are shared, and the index which is not shared is obtained as “2(DIV1)+1 (position value of F2)”, i.e., ‘3’. Accordingly, decoded result is (0, 3, 2) and face direction information is 1 so that (0, 3, 2) is rotated clockwise one time, thereby obtaining (2, 3, 0).

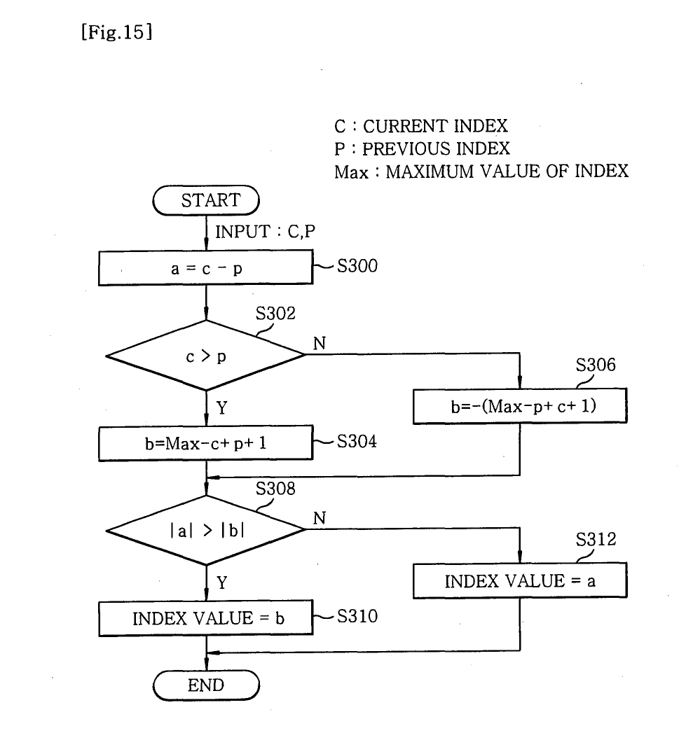

FIG. 15 and table 5 show a method that two differential values are calculated by circular difference method to reduce the DIV value in accordance with the present invention and the smaller value of the two absolute values of the differential values is used.

TABLE 5
Connectivity Information Coding By Circular Difference

| Face Index | | | | | | Face | | | |
|---|---|---|---|---|---|---|---|---|---|
| Information | | | | Type | Position | Direction | DIV1 | DIV2 | DIV3 |
| F1 | 0 | 1 | 2 | — | — | — | 0 | 1 | 2 |
| F2 | 2 | 3 | 0 | 2 | 1 | 1 | 2 | — | — |
| F3 | 4 | 5 | 0 | 1 | 2 | — | 2 | 2 | — |
| F4 | 0 | 3 | 4 | 2 | 1 | 1 | −2 | — | — |
| F5 | 5 | 6 | 1 | 0 | — | — | −3 | 3 | −3 |

Considering DIV1 of F5 in table 5 with reference to FIG. 15, a maximum index value of the VRML data used in this example is 7. Further, a general differential value is equal to “5−0=5” and is stored in the ‘a’ as shown in FIG. 15 (S300). In a step S302 comparing values of ‘c’ and ‘p’, ‘c’ is smaller than ‘p’ so that ‘b’ is equal to “−(7−5+0+1)=−3” (S306)

In a step S308 comparing values of ‘a’ and ‘b’, an absolute value of ‘a’ is larger than that of ‘b’ so that the difference value by the circular difference is −3. Consequently, the circular difference value is changed as shown in table 7. Here, when calculating the ‘b’ value in FIG. 15, ‘+1’ may be disregarded in both S304 and S306.

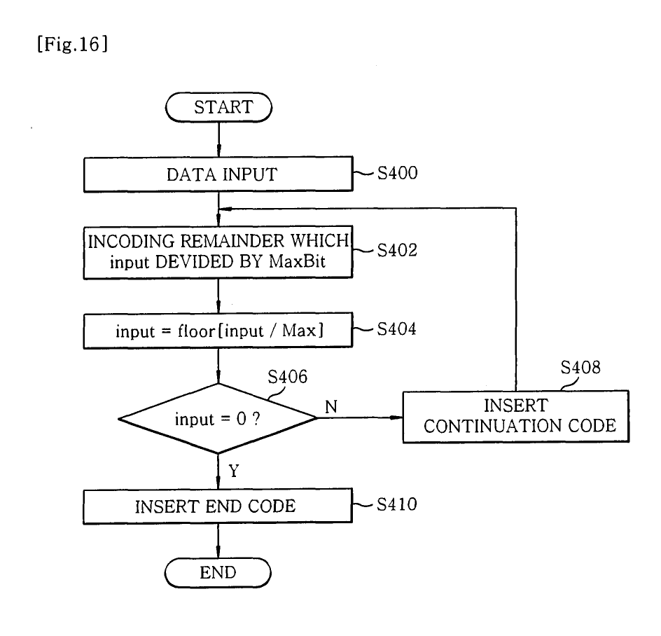

The processes of FIG. 16 are performed by inputting the calculated DIV values.

Referring to FIG. 16, ‘floor[ ]’ is round down operation. For example, if data input is 3000 (S400) and the Maxbit is 1024, 3000% 1024, i.e., 952 is encoded (S402) and an input is “floor[3000/1024]=2” (S404). Next, it is checked that whether the input is ‘0’ (S406) and if the input is not ‘0’, a continuation code is inserted (S408). Then, the changed input ‘2’ is repeatedly encoded. If the input is ‘0’, an end code is inserted (S410) and next input is coded.

Those skilled in the art will readily understand that steps of the present method can be implemented through general programming using various software and hardware technologies.

In addition, some steps of the present method may be implemented as computer-executable codes stored in a computer-readable storage medium. The computer-readable storage medium may be any of storage media that can store data readable by a computer system. Examples of the computer-readable storage medium include a ROM, RAM, CD-ROM, CD-RW, magnetic tape, floppy disk, HDD, optical disc, magneto-optical data storage, and carrier wave (for transmission through the Internet). The computer-executable codes may be distributed among and executed by computer systems connected through a network in a distributed manner.

While the invention has been shown and described with respect to the embodiments, it will be understood by those skilled in the art that various changes and modifications may be made without departing from the scope of the invention as defined in the following claims.

1. An apparatus for compressing low-complexity three-dimensional (3D) mesh, comprising:
a data analyzing unit for decomposing data of an input 3D mesh model into vertices information, property information representing property of the 3D mesh model, and connectivity information between vertices constituting the 3D mesh model;
a mesh model quantizing unit for producing quantized vertices and property information of the 3D mesh model by using the vertices, property and connectivity information;
a sharable vertex analysis unit for analyzing sharing information between shared vertices of the 3D mesh model;
a data modulation unit for performing a circular based DPCM prediction by using quantized values of the consecutive connectivity information of the 3D mesh model; and
an entropy encoding unit for outputting coded data of the quantized vertices and property information, and differential pulse-code modulated connectivity information as a bitstream.

2. The apparatus of claim 1, wherein the data analyzing unit comprises a microprocessor that computes a complexity value of the 3D mesh model, and subdivides, when the computed complexity value is greater than a preset complexity threshold, the 3D mesh model into multiple smaller mesh models.

3. The apparatus of claim 2, wherein the complexity value of the 3D mesh model is determined by the number of faces in a FaceSet.

4. The apparatus of claim 1, wherein the connectivity information is represented by an index list containing indices of multiple vertices forming a unit polygon.

5. The apparatus of claim 4, wherein the property information comprises normals, colors, and texture coordinates of unit polygons forming the 3D mesh model.

6. The apparatus of claim 1, wherein the data analyzing unit comprises a header storing data regarding the geometry, property and connectivity information of the 3D mesh model.

7. The apparatus of claim 1, wherein the data modulation unit further comprising:
a preprocessing unit for calculating difference values between pairs of consecutive data in order of index embedded in quantized connectivity information of the 3D mesh model and makes order of indexes in the pairs of data such that the difference values have minimum values, in order to reduce the difference values; and
a differential pulse-code modulation (DPCM) unit for performing a DPCM prediction according to the quantized connectivity information by using the consecutive connectivity information of the 3D mesh model.

8. The apparatus of claim 1, wherein the data modulation unit further comprising: a preprocessing unit for generating bits by dividing a face into triangles to be classified by a plurality of types according to the number of shared vertices between a previous face and a current face; and
a DPCM unit for performing a DPCM prediction after bits generated in the preprocessing unit are provided by using the consecutive connectivity information of the 3D mesh model.

9. The apparatus of claim 1, wherein the entropy encoding unit performs arithmetic coding, binary arithmetic coding and bit-precision coding on the vertex and property information of the 3D mesh model and the differential pulse-code modulated connectivity information and outputs the entropy coded-data of the 3D mesh model as bit stream type.

10. A method of compressing low complexity 3D mesh models, comprising: decomposing an input 3D mesh model into vertices information, property information representing property of the 3D mesh model, and connectivity information between vertices constituting the 3D mesh model;
producing quantized vertices, property and connectivity information of the 3D mesh model by using the vertices, property and connectivity information;
analyzing sharing information between shared vertices of the 3D mesh model;
performing a circular DPCM prediction by using quantized values of the consecutive connectivity information of the 3D mesh model; and
outputting coded data of the quantized vertices and property information, and differential pulse-code modulated connectivity information as a bitstream.

11. The method of claim 10, wherein decomposing the connectivity information between vertices constituting the 3D mesh model further comprising:
calculating complexity of the 3D mesh model; and
subdividing the 3D mesh model into multiple mesh according to the result of comparing complexity value of the calculated 3D mesh model and preset complexity.

12. The method of claim 11, wherein the complexity value is determined by the number of faces in a FaceSet representing the 3D mesh model.

13. The method of claim 10, wherein the connectivity information is represented by an index list containing indices of multiple vertices forming a polygon.

14. The method of claim 3, wherein the property information comprises normals, colors, and texture coordinates of polygons forming the 3D mesh model.

15. The method of claim 10, wherein decomposing the connectivity information between vertices constituting the 3D mesh model further comprises storing data regarding the vertex, property and connectivity information of the 3D mesh model.

16. The method of claim 10, wherein performing a DPCM prediction further comprising:
preprocessing by calculating difference values between pairs of consecutive data in order of index embedded in the quantized connectivity information of the 3D mesh model and making order of indexes in the pairs of data such that the difference values have minimum values, in order to reduce the difference values; and
performing the DPCM prediction by using the quantized value of the consecutive connectivity information of the 3D model according to the preprocessed connectivity information.

17. The method of claim 10, wherein performing a DPCM prediction further comprising:
preprocessing for generating bits by dividing a face into triangles to be classified by a plurality of types according to the number of shared vertices between a previous face and a current face; and
performing a DPCM prediction after bits generated in the preprocessing unit are provided by using the consecutive connectivity information of the 3D mesh model.

18. The method of claim 10, wherein outputting coded data further comprises performing arithmetic coding, binary arithmetic coding and bit-precision coding on the vertex and property information of the 3D mesh model and the differential pulse-code modulated connectivity information and outputs the entropy coded-data of the 3D mesh model as bit stream type.

19. (canceled)
